(19) United States
(12) Patent Application Publication
(10) Pub. No.: US 2016/0321679 A1
(43) Pub. Date: Nov. 3, 2016

(54) DEVICE AND MEMBERSHIP IDENTITY MATCHING

(71) Applicant: International Business Machines Corporation, Armonk, NY (US)

(72) Inventors: Wei Shan Dong, Beijing (CN); Meng Xiang Lin, Beijing (CN); Hong Peng, Beijing (CN); Chun hua Tian, Beijing (CN); Ke Fei Wang, Beijing (CN)

(21) Appl. No.: 14/700,876

(22) Filed: Apr. 30, 2015

(51) Int. Cl. G06Q 30/02; H04W 4/02

(52) U.S. Cl. CPC G06Q 30/0201; H04W 4/02

(57) ABSTRACT

Apparatus and method for a physical store to associate a mobile device identity with a customer's membership card ID. A non-intrusive solution automatically builds a link between the identified device d and a recorded transaction associated with a membership card ID. The method builds a device visiting journey trajectory for a device d from data recording the physical movement of that device d obtained from an in-store locating system, and Points of Interest data information. There is further built from purchase transaction data and data representing a physical store layout, a member's procurement journey. A membership matching engine analyzes the spatio-temporal occurrences and sequences used to build up the feasible link and their binding possibility. In addition, the system can also use historical data and update the linkage and binding possibility adaptively. The system automatically detects the membership card and device matching without asking customer to perform the binding manually.

### FIELD

The present invention relates to in-store locating systems and methods that assist physical stores to better understand customers' browsing and/or purchasing behaviors, and the implementation of an infrastructure that provides for automatic user device identity mapping to a membership ID identity without explicit manual work.

### BACKGROUND

In-store locating becomes a trend for physical stores to better understand customers' browsing and/or purchasing behaviors. Current in-store locating infrastructures implement systems and methods that can record the movement of a wireless communication (WiFi) device (e.g., a mobile phone or smart phone) within a physical department store at a precision within 2 m.˜10 m. In such current in-store locating systems, only anonymous customer tracking data is obtained and only anonymous customer analysis can be done for general customer traffic analytics.

In one embodiment, a current “cookie” based solution is available as shown in FIG. 1. In such a system 10, a device identification platform user-side solution implements user-side software that gathers device information. FIG. 1 shows a current implemented “cookie” based solution in which a cookie “matching” service 12 is employed that extracts user cookies from the user device side software 15 that is in communication with a service that facilitates an on-line browsing/purchase service 20.

Additionally, are hosted web-based platforms that create a persistent and seamless electronic fingerprint based on the unique characteristics of any connected device. For example, the Bluecava® platform (BlueCava, Inc.) provides hosted intelligent services to analyze device information and calculate a fingerprint.

However, no current solution exists for binding, i.e., matching, a customer's device identification (ID) with a membership card identifier (ID), that is seamless to the customer.

### SUMMARY

There is provided system, method and computer program product to provide an infrastructure that provides for an enhanced target campaign or precise marketing that is dependent upon the link between device ID with membership ID.

There is provided an improved in-store locating system that performs automatic identity mapping based on recognizing a user's mobile device phone presence in a store location and using the mobile device information for recognizing the corresponding user as being a member of the store.

By tracking the user movement within the physical store, there is built that user's browsing and/or purchasing behavior. As a consequence, a recognized customer may be steered to a targeted sales agent or sent targeted coupons or be available to receive promotions based on the mapping to the customer's membership, and/or based on the customer's detected browsing and/or purchasing behavior(s).

According to one aspect, there is provided a method for automatic binding of a membership card identifier (ID) with a mobile device identifier (ID). The method comprises: tracking, using a wireless electronic device tracking system, physical locations of one or more stores visited by a customer's mobile electronic device, the tracking including identifying the customer's mobile device identifier (ID); building, at a processor device, a first data structure representing a trajectory corresponding to the movement of the customer's tracked mobile electronic device at one or more store locations, and a time interval thereof corresponding to an amount of time visited at each location; building, at the processor device, a second data structure representing one or more purchase transactions conducted by customers at various store locations, each customer purchase transaction indicating a membership card ID associated with the customer, and a corresponding purchase payment time point; and identifying, at the processor device, from the first and second data structures, a compatible match indicating a potential binding of a customer's mobile device ID to a membership card ID, the identifying a compatible match including detecting when a purchase payment time point associated with a customer membership card ID and for a purchase conducted at a particular store location matches a time interval window recorded for a tracked customer mobile device detected at that store location, wherein the compatibility match identifying occurs seamless to the customer.

According to a further aspect, there is provided a system for automatic binding of a membership card identifier (ID) with a mobile device identifier (ID). The system comprises: a wireless electronic device tracking system for tracking physical locations of one or more stores visited by a customer's mobile electronic device, the tracking including identifying the customer's mobile device identifier (ID); a memory storage device, and a hardware processor device coupled to the memory storage device, the hardware processor configured to perform a method to: build a first data structure representing a trajectory corresponding to the movement of the customer's tracked mobile electronic device at one or more store locations, and a time interval thereof corresponding to an amount of time visited at each location; build a second data structure representing one or more purchase transactions conducted by customers at various store locations, each customer purchase transaction indicating a membership card ID associated with the customer, and a corresponding purchase payment time point; and identify from the first and second data structures, a compatible match indicating a potential binding of a customer's mobile device ID to a membership card ID, the identifying a compatible match including detecting when a purchase payment time point associated with a customer membership card ID and for a purchase conducted at a particular store location matches a time interval window recorded for a tracked customer mobile device detected at that store location, wherein the compatibility match identifying occurs seamless to the customer.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE SEVERAL VIEWS OF THE DRAWINGS

Other aspects, features and advantages of the present invention will become more fully apparent from the following detailed description, the appended claims, and the accompanying drawings in which similar elements are given similar reference numerals.

FIG. 1 shows a block diagram of an example prior art in-store tracking techniques;

FIG. 2 illustrates a schematic diagram of a system 50 for the automatic binding of a customer's membership to a matched device in one embodiment;

FIG. 3A shows an example POI journey trajectory for a customer based on data tracked by the system and built by the Device's POI Visiting Journey Builder module in one embodiment;

FIG. 3B shows an example output data schema for a built customer journey trajectory in one embodiment;

FIG. 4A shows an example transaction sequence for an example POI journey trajectory for a customer based on data tracked by the system and built by the Membership's procurement list constructor module in one embodiment;

FIG. 4B shows an example output data schema for the customer transaction sequence corresponding to the built customer trajectory in one embodiment;

FIG. 5A shows a further example transaction sequence for the example POI journey trajectory for a customer based on data tracked by the system and built by the Membership's procurement list constructor module in one embodiment;

FIG. 5B shows the further example output data schema for the customer transaction sequence corresponding to a built customer trajectory in one embodiment;

FIG. 6 shows a non-intrusive method implemented in the Device-Membership Matching Engine for matching a customer membership with a detected device (in the store) in one embodiment;

FIG. 7 shows the device-membership matching methodology 100 corresponding to the compatible device detection step of FIG. 6 in one embodiment;

FIG. 8A shows an example compatibility checking methodology performed at 105, FIG. 7, for determining whether the detected customer mobile device is compatible with a store membership card ID or other membership ID according to a first example payment scenario;

FIG. 8B shows an example compatibility checking methodology performed at 205 for determining whether the detected customer mobile device is compatible with a store membership card ID or other membership ID according to a second example payment scenario;

FIG. 9 depicts conceptually one embodiment implementing a in-store device tracking system for selecting a neighborhood 35 of multiple customer mobile devices for detection and binding;

FIG. 10 shows a method 300 for managing binding updates according to one embodiment; and

FIG. 11 depicts an exemplary hardware configuration for performing methods such as described in FIGS. 7, 8A-8B, and 10 in one embodiment.

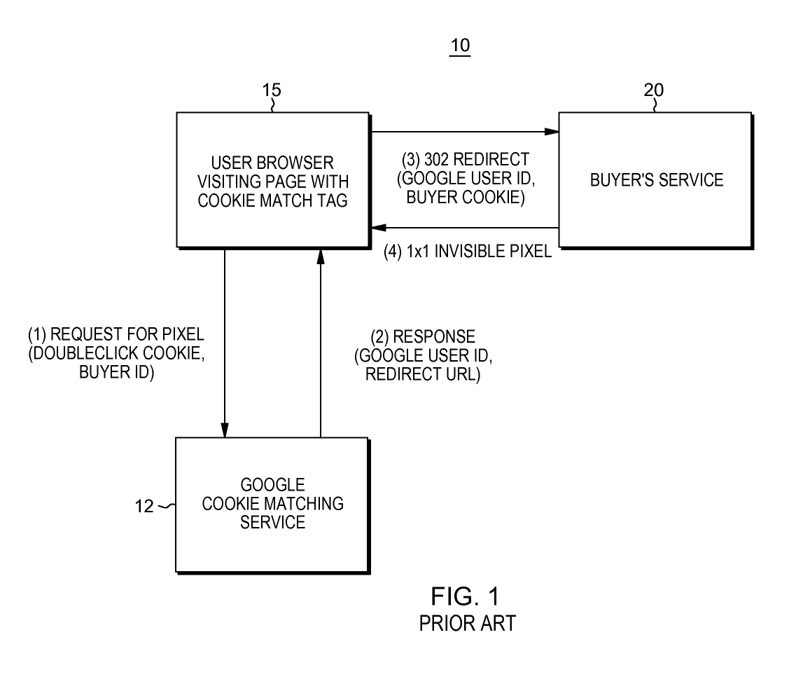

### DETAILED DESCRIPTION

A system, method and computer program product for a store, business or retail establishment to automatically detect a customer's device when in the store and identify a membership associated with that customer's device, i.e., the automatic binding of a customer's membership to a matched device. The membership card and matching thereof to a customer's device is performed without asking customer to do the binding manually. As a result, the store, business or retail establishment may wirelessly communicate coupons, discounts or rewards to targeted customer/members.

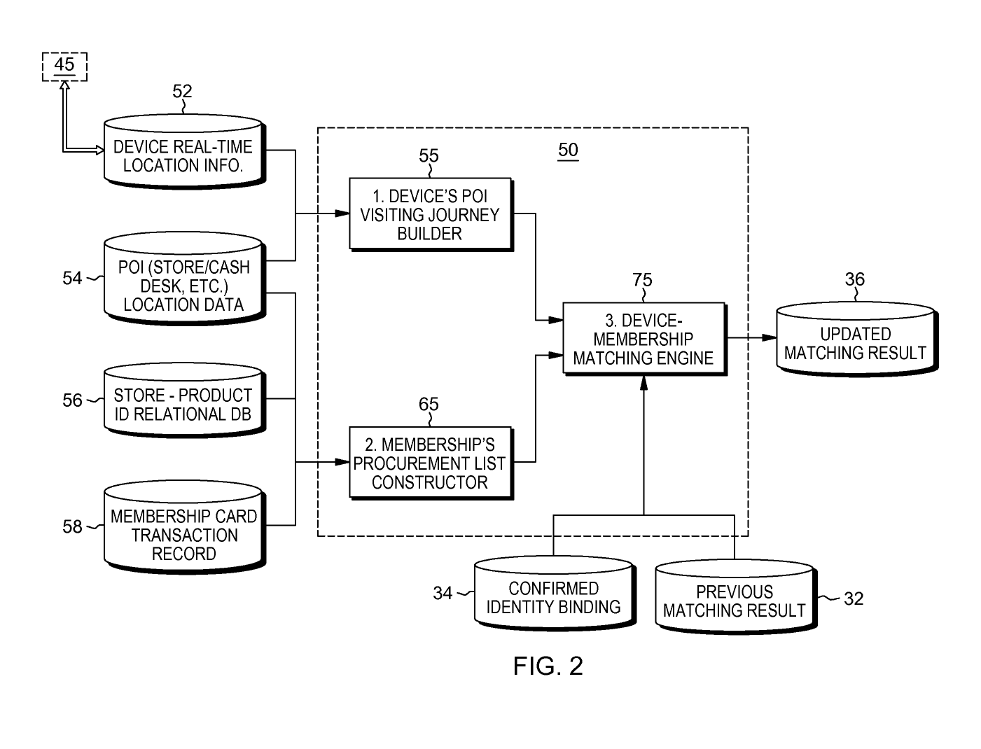

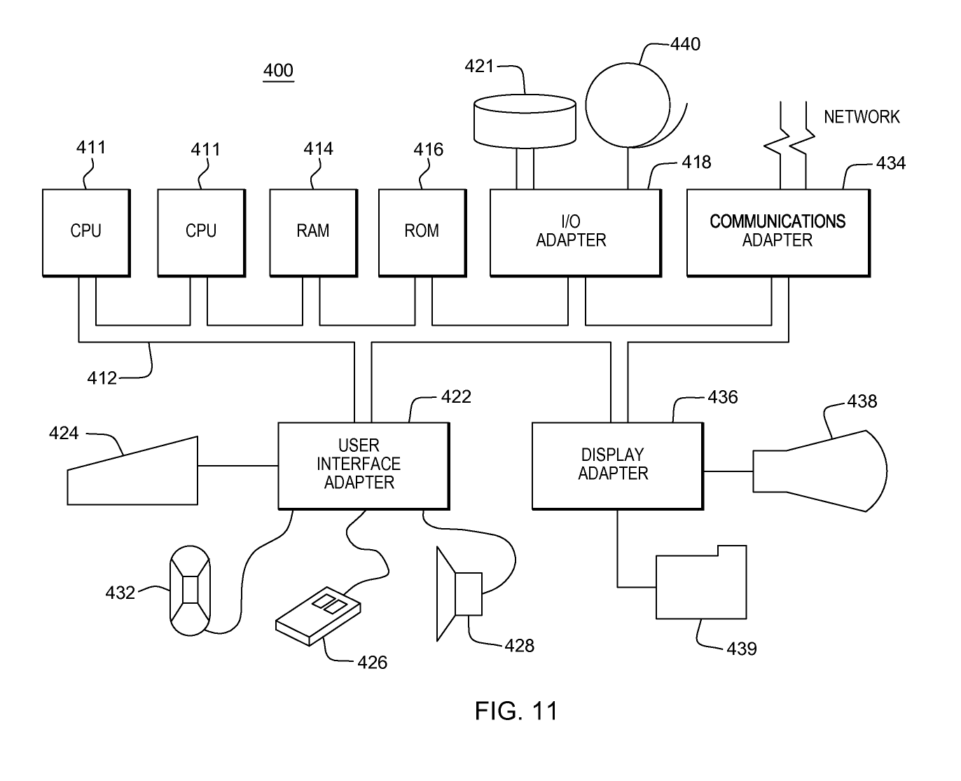

FIG. 2 illustrates a schematic diagram of a system 50 for the automatic binding of a customer's membership to a matched device in a manner that is seamless to the customer. As shown in FIG. 2, the system 50 includes three main processing components: 1) a Device's POI Visiting Journey Builder module 55 implementing programmed method steps to track one or more customer's visiting points of interest (POI), e.g., over one or more time interval(s); 2) a Membership's procurement list constructor module 65 implementing programmed method steps to track those one or more customer's conducted purchasing transactions at the various one or more POI over the time interval(s); and 3) a Device-Membership Matching Engine 75 which implements the functionality for the automatic binding, i.e., matching of a customer's membership to a customer's matched device. Each module implements methods embodied as program instructions stored in a tangible memory storage device and run by a hardware processor of a computing apparatus such as the exemplary hardware configuration described herein with respect to FIG. 11.

In one embodiment, data is maintained for use by the system 50, and/or can be accessed from databases external to the system 50, via a network, for use by the various modules. For example, a first data obtained and stored in a memory storage device, e.g., a database, includes Real-time Device Location Information 52 which data is obtained in real-time from an implemented WiFi in-store device location system 45. Such a system 45 uses a device to wirelessly and in substantially real-time track a user's movement within the store. Besides such systems tracking a customer location, via the device, such systems further enable customers to find products and receive promotions for nearby products. The data 52 generated indicates, for each in-store customer, where in the store a customer has walked around, and where they had dwell. Many in-door locating systems (e.g., Present Zone V1.0 product from International Business Machines, Inc.) collect and store such kind of location information.

In the present disclosure, a customer's activated mobile device may be tracked and a device identifier obtained which is mapped to a customer identifier, e.g., a membership card ID belonging to a club member, or a credit card ID number or banking card ID number. Using a mobile device WiFi signal, a customer/member can be real-time tracked, and implementing methods herein, logic implemented to determine a binding of a customer device d with a membership card ID. Once a customer having a membership card ID m is bound to device ID, the customer may specifically receive additional in store product promotions, coupons, or bargains, etc., via their mobile device. From this real-time tracking of in-store device location data is obtained and stored, a customer's shopping habits and points of interest visited are determinable. For example, based on a device to customer membership mapping, that customer device may receive a targeted coupon or promotion, e.g., via an e-mail, text message, or mobile application, of the identified customer matched to the device.

In one embodiment, a second data obtained and stored in a memory storage device, e.g., a database, includes POI (Store/Cash Desk, etc.) Location Data 54 which is reference data mapping points of interest to physical in-store or distributed (e.g., within a mall) store locations. Each POI data, e.g., store or in-store location, may have an associated identifier (POI_ID). In one embodiment, the associated identifier may be a point of purchase terminal identifier in which the customer has conducted a purchase transaction, or dwelled for an extended period of time.

POI granularity specification can vary and may be a “big-box” store (e.g., a super market), or a specific store (e.g., like a specific store within a department store), or zone area within a super market. In one embodiment, any area a customer may “visit” conceivably may be designated as a point of interest.

In one embodiment, a third data obtained and stored in the same or different memory storage system, e.g., a relational database, includes Store-Product ID data 56 which is data representing information mapping a store or entity's product to a product identifier such as a SKU number (stock keeping unit) associated with an item for sale, e.g., product or service. This reference data can be used to uniquely determine stores carrying certain products that users' may have visited or conducted transactions within the time interval or prior time intervals.

In one embodiment, a fourth data obtained and stored in a memory storage device, includes Membership Card's Transaction Record(s) 58. This data maps each user's purchase of a particular product, e.g., at a store or business location, to an associated club membership ID, a bank card ID, credit card ID or debit card ID, company, etc., by mapping such a membership card identifier (“membership card ID”) to the recorded user transaction. In non-limiting embodiment, such membership card identifier may be a club or membership ID number associated with the customer, a credit card or debit card number associated with the customer, a bank card number or some other identifier based on user purchase histories. The data 58 includes products associated with past (historical) purchase transactions conducted by the identified membership card ID at a store. This gives insight of that identified customer's purchasing habits and/or browsing behavior to perform a more targeted marketing, for example, send a coupon, or dispatch a specialized sales agent for targeted promotion.

As shown in FIG. 2, in the system, the Device's POI Visiting Journey Builder module 55 implements programmed method steps to access and process the customer device real-time location data and customers' visiting points of interest (POI) data, e.g., in the store, and process the Real-time Device Location Information 52 and POI (Store/Cash Desk, etc.) Location Data 54 to track one or more customer's visiting points of interest (POI), e.g., over one or more time interval(s), and build corresponding customer POI journey trajectories.

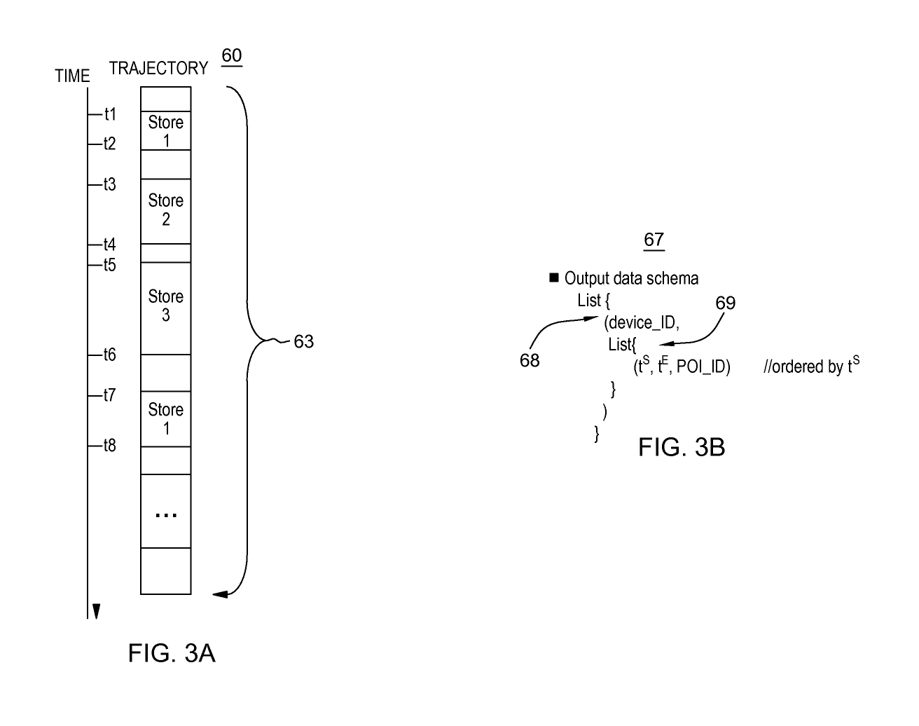

FIG. 3A is a visualization of an example POI journey trajectory 60 for a customer based on customer device location data tracked by the system and POI location data built by the Device's POI Visiting Journey Builder module 55. As shown in FIG. 3A, an example customer trajectory 60 is built that includes the physical store locations the customer has traversed over a period of time, a “journey”, e.g., over a course of a day. For example, in-store wireless sensor technology or like wireless mobile device detection technology has recorded customer devices (device_IDs) at various physical locations, i.e., points of interest. These may include recent visited stores that customer (and the customer device) has visited over a period of time (time interval) 63. In the example trajectory 60 shown, over time interval 63 the example customer has been recorded to have visited and/or made purchases in at various points of interest in a sequence of in-store locations including being at a store 1 from time t1-t2, a store 2 from time t3-t4, and a store 3 at time t5 to time t6 and back again to a store 1 at time t7-t8. This embodiment assumes this transaction data from distributed store locations (e.g., a credit-card company) is available for the store purposes. In this example, each store 1-store 3 may be located at various “in-store” locations, e.g., within a department store, “big-box” retailer, mall, or other entities locations in which purchase of items (products or services) is provided. In one embodiment, the store locations may be remotely distributed. The Device's POI Visiting Journey Builder module 55 generates output data representing this trajectory for each customer device according to a schema.

FIG. 3B shows an example output data schema 67 for the built customer trajectory. The schema 67 may include a List 68 including one or more device_IDs (an identifier such as a MAC address or some other identifier of each customer's device), and a list 69 of the corresponding physical locations (POI(s)) that each device_ID has visited in a time interval, i.e., List{(t^{S}, t^{E}, POI_ID). The t^{S} represents a start time (time of entry) at that in-store or external store location, t^{E} represents the corresponding exit time at that internal (in-store) location or external store, and POI_ID_represents the store in which the customer has visited between the corresponding entry and exit times. In the example, the list may include the trajectory output schema may be ordered by the time t^{S}.

Returning to FIG. 2, in like manner, the system's Membership's procurement list constructor module 65 implements programmed method steps to access and process the (in-store) Store-Product ID (SKU data) data 56 and Membership Card's Transaction Record(s) 58 for a customer and the store's POI data 54 to track those one or more customer's conducted purchasing transactions at the various one or more POI over the time interval; and build corresponding customer POI transaction sequence trajectory. The membership identifier may include a membership card number, e.g., a club membership number (e.g., “CostCo” or “GMC”), a debit card number or credit card number, obtained from a record of the customer's payment, made available to the module. The constructor method accommodates both payments made at the store (in-store payments) and centralized payment schemes.

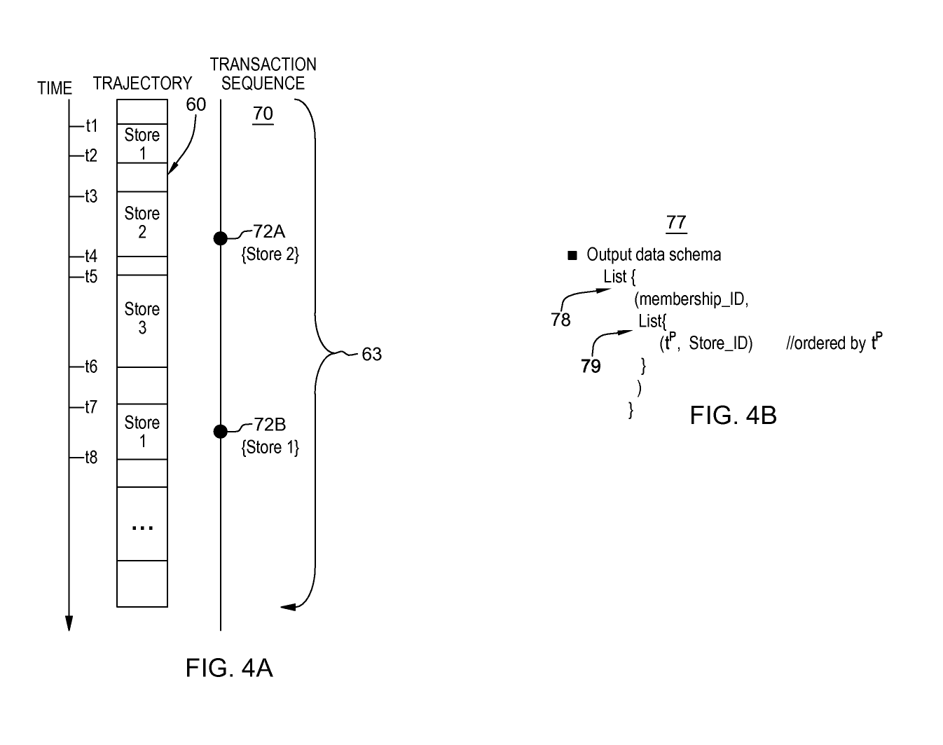

FIG. 4A shows an example customer transaction sequence 70 for the example POI journey trajectory 60 according to a first local (in-store) payment scheme for a customer based on data tracked by the system 50 and built by the Membership's procurement list constructor module 65. In the example shown, an example constructed procurement transaction sequence 70 is shown constructed based on the example customer trajectory 60 for the example customer shown in FIG. 3A. This data may be obtained and provided by the various point of purchase terminals which record transactions, e.g., customer purchases, at a particular store or in-store location over the same time interval 63. In the example trajectory 70, the example customer has been recorded to have conducted a purchase transaction for a particular item (e.g., a product) at a time 72A when that customer had visited store 2, and conducted a purchase transaction for a particular item at store 1 when the user returned back during his/her journey at time 72B. The system's Membership's procurement list constructor module 65 generates output transaction sequence data for each customer device according to a schema.

FIG. 4B shows an example output data schema 77 according to a first local (in-store) payment scheme for the customer transaction sequence 70 corresponding to the built customer trajectory 60 generated by the Membership procurement list constructor module 65. The schema 77 may include a List 78 including the customer membership_ID, and a representations of the locations that membership_ID has made an associated purchase, e.g., List{(t^{P}, Store_ID). The t^{P} represents a payment time point (time of the respective purchase), and Store_ID represents an identification of a location or store in which the customer has conducted the purchase(s). In the example, the output list of the output transaction schema may be ordered by the time t^{P}.

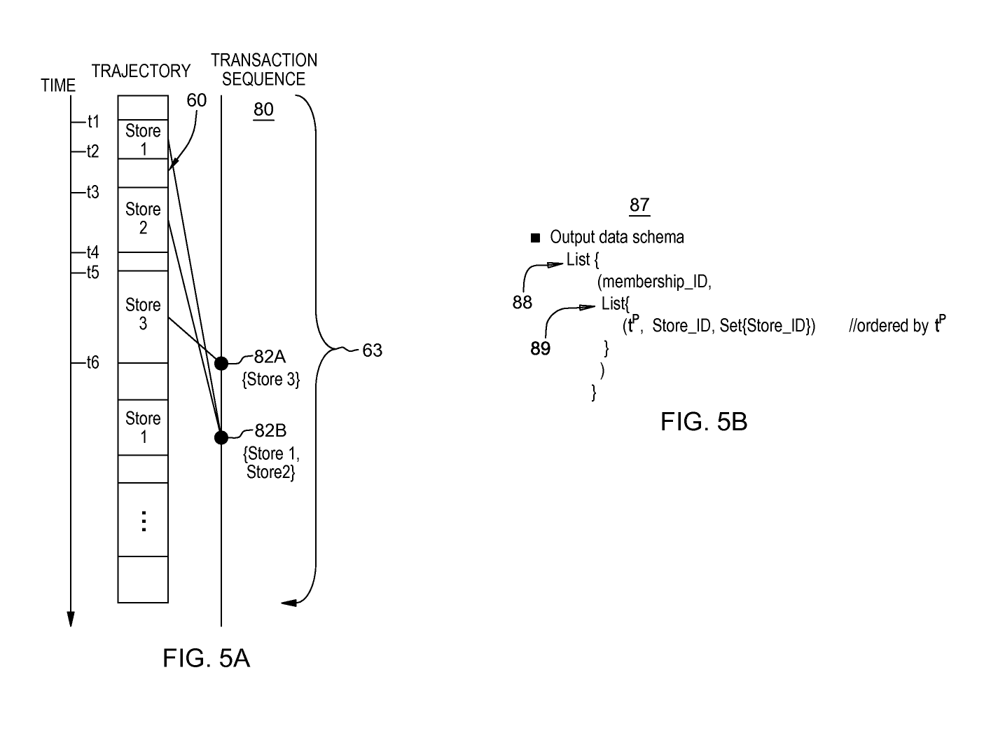

FIG. 5A shows an example customer transaction sequence 80 for the example POI journey trajectory 60 according to a second centralized payment scheme for a customer based on data tracked by the system 50 and built by the Membership's procurement list constructor module 65. The constructed procurement transaction sequence 80 is constructed based on the time-shifted payments of purchase transactions based on a centralized payment scheme. In such scheme, services are invoked in which customers, e.g., at a department store, receive receipts for their purchases at payment time points t_{P}, and then pay later at a location associated with a centralized entity (e.g., a bank, a credit, or governmental entity) or like entity that accepts the payment associated with the receipt and provides the customer with a proof verifying customer payment receipt by the authorized entity. Upon return to the store and presentation of the authorized payment proof back at the department store, the purchase can then be fulfilled and the customer can receive the physical product purchased. Thus, for the example customer trajectory 60 for the example customer shown in FIG. 3A, this data may be obtained from or provided by the centralized entity which provides the proof receipt(s) for the actual purchase(s) at the particular store or in-store locations, over the same time interval 63. In the example shown in FIG. 5A, the central “desk” has recorded at a payment time point 82A for a particular item associated with a first purchase transaction, e.g., a payment time point for a product previously purchased at store 3 between times t5 and t6, for the customer. In the time interval 63, the central “desk” has recorded a further payment time point at a time 82B associated with second and third prior purchase transactions for a particular item(s) (e.g., a product) conducted when visiting at store 1 locations and store 2 locations, respectively, for the customer, prior purchased between times t1-t2 and times t3-t4, respectively. The system's Membership's procurement list constructor module 65 generates output transaction sequence 80 data for each customer device according to a further schema.

FIG. 5B shows the further example output data schema 87 for the customer transaction sequence 80 corresponding to a built customer trajectory. The schema 87 may include a List 88 including the customer membership_ID, and a representation of the identities of locations/entities accepting payment for that customer membership_ID for the associated purchases, e.g., List{(t^{P}, Desk_ID, Set{Store_ID})} as data 89. The t^{P} represents the purchase time points at the individual stores, Desk_ID represents the identifier of the centralized authority or entity receiving payment for the item purchased for the customer; and Set{Store_ID} represents an identification of each respective store location or store in which the customer of membership_ID has conducted the purchase(s) that are being centrally paid at the Desk_ID location. In one embodiment, t^{P} may be the time of the purchase transaction payments at the central authority “cash desk” for the customer membership ID, e.g., “m”. In the example, the output list of the output transaction schema may be ordered by the time t^{P}.

Returning to the system diagram of FIG. 2, in the device-matching determination, the Device-Membership Matching Engine 75 accesses the output schema data 67 for a customer associated with the detected device ID e.g., a built POI visiting journey, output from the Device's POI Visiting Journey Builder module 55 for a specified time interval(s). The Device-Membership Matching Engine 65 further accesses the output schema data 77, 87, e.g., a customer's associated constructed transaction sequence by the Member's procurement list constructor module 65 for the specified time interval(s) and implements the functionality for the automatic binding, i.e., matching of a customer's membership to a customer's device. It is understood that the identification of a product purchased by the customers is already present in the system, e.g., via a bar-code scan of the product, which is recorded in a transaction record at the time of purchase.

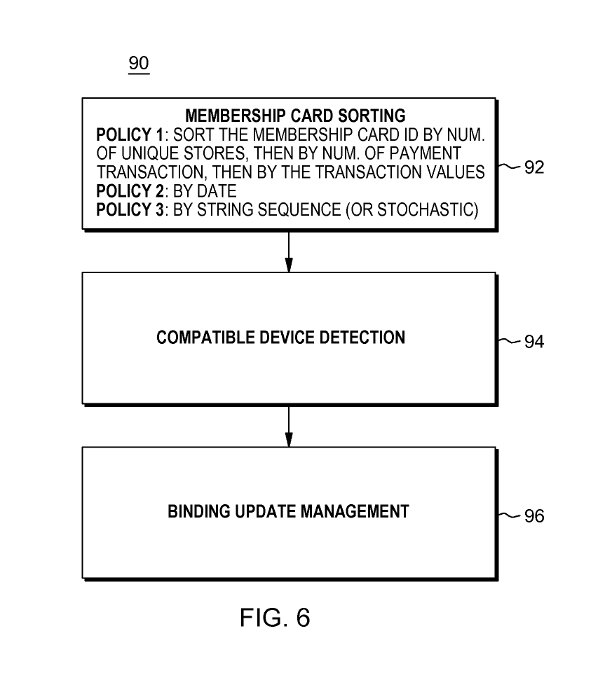

FIG. 6 shows a non-intrusive method 90 implemented in the Device-Membership Matching Engine 75 for matching a customer device ID with a membership ID (e.g., club membership number, bank card number, credit or debit card number) with a detected device (in the store) and/or determine whether a Device ID matches a customer who is a member. Based on the matching, that customer's habits may be analyzed, e.g., for potential issuance of targeted coupons/promotions at the particular store(s) for that customer. The method of FIG. 6 provides a non-intrusive solution to automatically build the links comprising the data from the locating system and POI (Point of Interest) information, the built device POI visiting journey; and from the transaction data and physical store layout data, and the constructed membership procurement data.

As shown in FIG. 6, in one embodiment, the methodology 90 implemented by the matching engine 75 at the physical store to associate a mobile device identity with membership identity (e.g., membership card ID) may include running the matching engine in one of three modes: 1) a “stepwise” mode of operation which updates the binding possibility for each customer visiting the in-store location by running steps 92, 94 and 96 in a sequence for each identified customer. That is, Device-Membership Matching Engine 75 implements a Membership Card Sorting method 92, a Compatible Device Detection method 94, and a Binding Update Management method 96 for each new customer visiting; 2) a “batch” mode of operation which uses long-term co-occurrences to join device-membership matching and subsequently will run steps 92, 94 of method 90 based on multiple customer visits, and then update the binding at a subsequent time; or 3) a “mixed” mode of operation which runs each step 92, 94, 96 for each visiting, but in addition, also performs a batch checking based on a period of visits. Thus, for example, as the matching algorithm may be performed in batch (e.g. every day), with many card IDs so a sorting is performed to decide which cards to be processed first.

Returning to FIG. 2 results of the Device-Membership Matching Engine 75 processing can be stored in one or more databases 32, 34 and 36 which store “Matching Results”. For example, in one embodiment, “matching” may be performed in an iterative way, such that database 32 and 34 may store the “prior” device-membership card matching or “confirmed” results, respectively, while database 36 stores the post-matching (or updated) device-membership card matching results. In one embodiment, databases 32, 34 and 36 may be consolidated as a single database.

In FIG. 6, the device matching engine membership card sorting method 92 attempts to organize and correlate the obtained output data from the Device's POI Visiting Journey Builder module 55 and the Member's procurement list constructor module 65 for a specified time interval(s) for purposes of device-membership matching. In one embodiment, customer's card membership information is organized according to one or more policies. In a first example policy (Policy 1) the method includes sorting a customer's membership card ID by a number of unique stores, then by number of payment transactions, and then by the transaction values. In a second example policy (Policy 2) the method includes sorting a customer's membership card ID according to date. In a third example policy (Policy 3) the method includes sorting a customer's membership card ID according to a string sequence (or stochastic), i.e., no explicit sorting is conducted, processing can follow the sequence form the original data source. As an example of Policy 1, the customer identified as having a membership ID number may have an associated list comprising a set S of set of stores.

Then, at 94, a Compatible Device Detection step is performs the physical matching of the device_ID to a membership card ID (e.g., club membership number, banking card, credit card number). In one embodiment depicted, the compatible device detection occurs in real-time when the customer is physically located within the store, however it is understood that the method steps 92-96 may be performed in an off-line process.

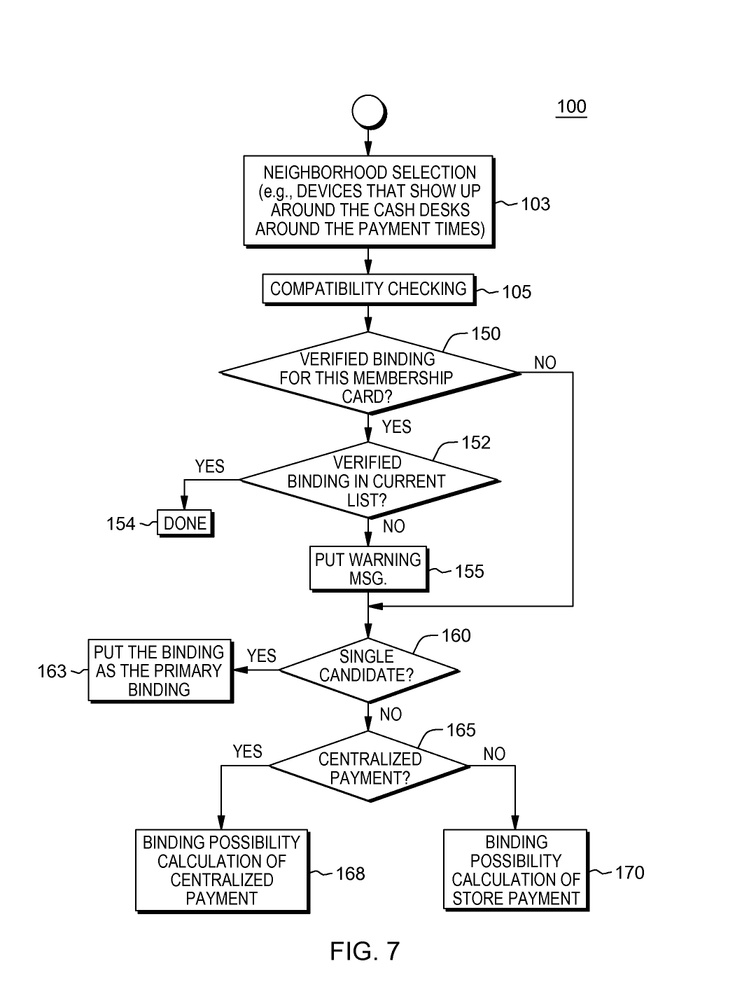

FIG. 7 shows the device-membership matching methodology 100 corresponding to the Compatible Device Detection step 94 of FIG. 6. In the method 100 of FIG. 7, a first step 103 includes determining an identifier of a WiFi activated customer device (a device ID) at a determined location, e.g., a payment transaction terminal within the store. For purposes of description, a “stepwise” mode is implemented where the device matching engine runs steps in a sequence for each customer device ID found. Thus, in FIG. 7, at 103, the in-store tracking system first selects a “neighborhood” of devices of customers that show up around the cash desks around the payment times.

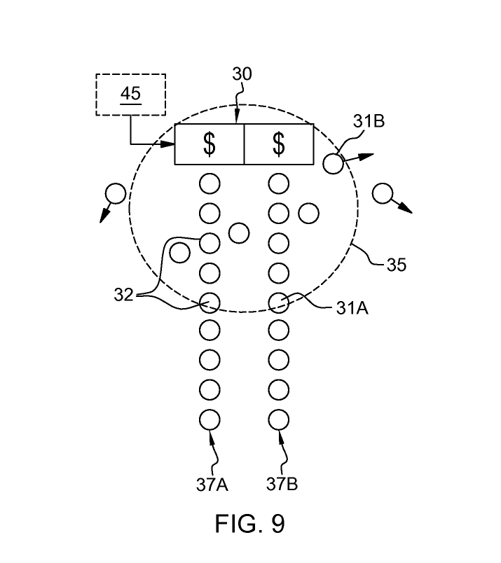

FIG. 9 depicts conceptually one embodiment for selecting a neighborhood (e.g., a geo-fence area) 35 within which multiple customer mobile devices d 32 are tracked for purposes of compatibility checking. In one embodiment, the neighborhood spans an area 35, e.g., a circumference of a few feet diameter, at or near a point or purchase register or payment terminal (e.g., at an in-store payment location) or a “cash desk” payment location 30 (i.e., corresponding to a central payment scheme), at a customer payment transaction time(s). Implementing the WiFi or like wireless in-store location and tracking system 45 at the store location, e.g., entrance, or when standing in payment queues 37A, 37B within detection area 35 at near payment terminal 30, mobile phone devices 32 owned by customers having activated WiFi communication circuitry may be detected by the store location and tracking system 45 using known techniques. In one embodiment, in-store activity uses in-store sensors that sense signals from said devices from which a device identifier (e.g., a device_ID such as a MAC address) can be recognized for wirelessly tracking the movement of that customer's personal digital device, e.g., mobile or smart phone, within the store. From the detected mobile devices, device_ID information are obtained, and a customer and/or membership ID (e.g., store membership, a membership club, a banking, credit or debit card number) may be determined. Returning to FIG. 7, once the device ID for a customer is obtained at 103, then at 105, the method performs compatibility checking for determining whether any of the devices appearing in the selected neighborhood are “compatible” with a particular membership ID.

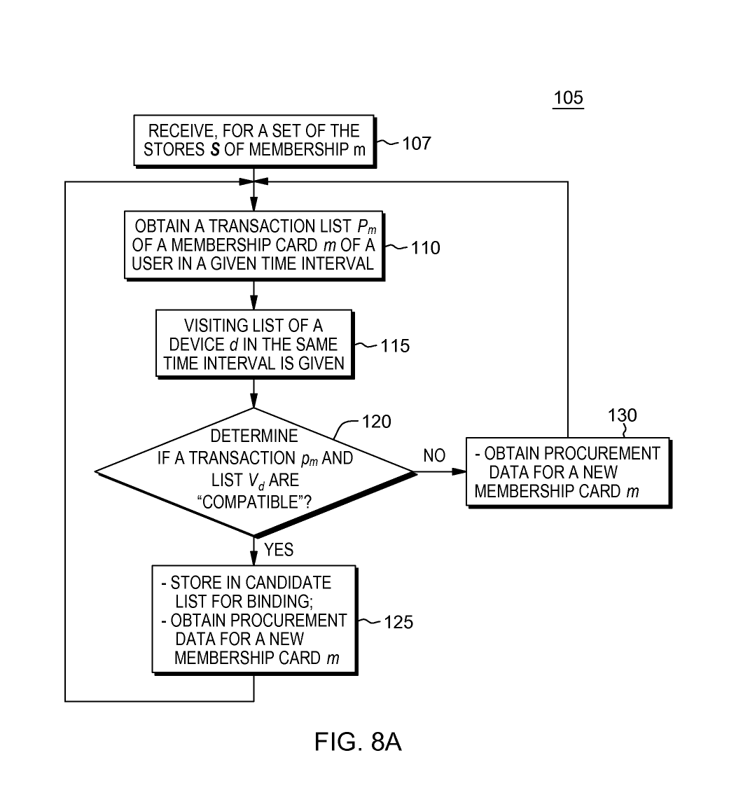

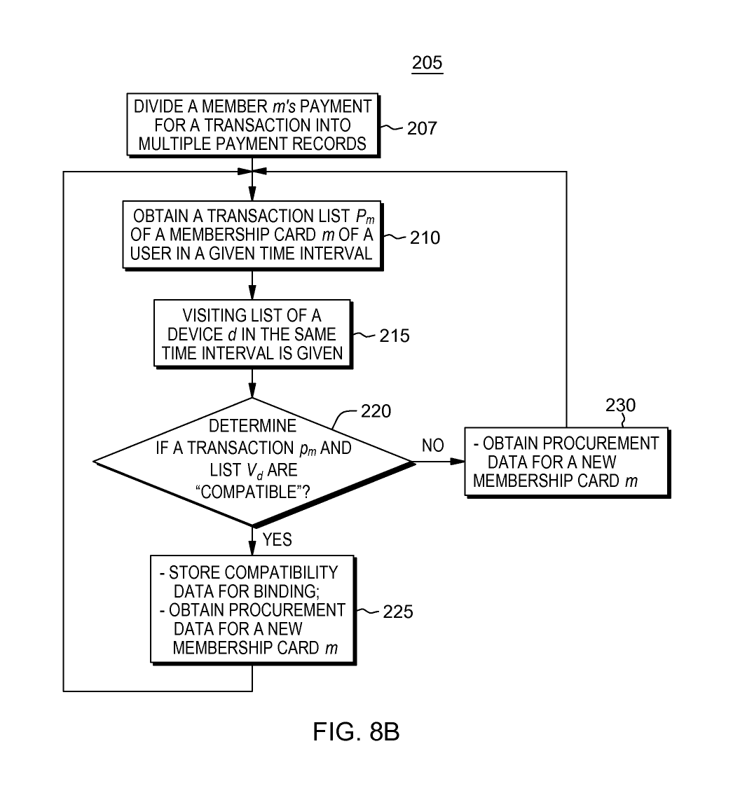

FIG. 8A shows an example compatibility checking methodology performed at 105, FIG. 7, for determining whether the detected customer mobile device is compatible with a store membership card ID or other membership ID, e.g., according to a first example scenario in which user transaction payments are conducted at each store. These method steps 105 are invoked to determine whether the detected customer device 32 belongs to or matches a customer membership (e.g., membership ID, banking or credit card number, etc.) or not. In this example scenario, the method includes: denoting a set of stores as S listing each store(s) for which a device (of device ID) has been tracked in the time interval; and at 110, generating at the device matching engine, from the stored data 58, a payment transaction list Pₘ for payments/transactions associated with a customer having a membership card m in the given time interval, e.g., one day, according to:

Pₘ=List{Pₘᵢ=(tₘᵢ,sₘᵢ):i=1,2 . . . pₘ,sₘᵢεS}

wherein tₘᵢ are the transaction(s) payment timestamp(s) of a membership card m belonging to a customer of a corresponding procurement i (i.e., transaction at a store), and sₘᵢ is the respective store in which transactions had been conducted (transaction or procurement i) by a customer associated with membership card m. The method further includes at 115, generating at the device matching engine, from the stored data 52, a “Visiting” device list V_{d} comprising a list of those devices d detected a store j in the same time interval, e.g., one day, as given as:

V_{d}=List{v_{dj}=(t_{dj}^{S},t_{dj}^{E},s_{dj}):j=1,2, . . . v_{d},s_{dj}εS}

wherein t_{dj}^{S} is a detected start time of entry of a device d in a store s_{dj}; t_{dj}^{E} is a detected time of exit of the device d from the store s_{dj} and s_{dj} is the identification of the store for that device d where j is the index of the particular store (within the set S of stores).

Then, at 120, FIG. 8A, the device matching engine performs compatibility checking by determining whether the transaction list Pₘ and the visiting list V_{d} are “compatible” with each other. A transaction list Pₘ and a visiting list V_{d} are “compatible” with each other if the following condition is met:

∀i=1,2, . . . ,pₘ,∃jε[1,v_{d}],whence tₘᵢε[t_{dj}^{S},t_{dj}^{E}] and sₘᵢ=s_{dj}

That is, for compatibility checking at 120, for each procurement i a determination is made as to whether any procurement transaction timestamp tₘᵢ for a customer membership card m conducted at a store sₘᵢ physically matches any of the window of time periods [t_{dj}^{S},t_{dj}^{E}] recorded for a tracked device d detected at that store, and that the stores are the same, i.e., sₘᵢ=s_{dj}. This could be performed in real-time, as the data becomes available, or in batch, or off-line mode. For any compatibility match detected, this potentially indicates that the customer associated with the matched device d may be the same customer who had conducted the transaction at times tₘᵢ with a membership card m, i.e., the customer's payment time to a SKU (belonging to the store) is within that customer's stay duration in that store.

Thus, at 120, if it is determined that the device d is compatible with the transaction i conducted at that store based on the spatio-temporal matching of both, then this information is stored at 125 in a database. Returning to FIG. 2, the “Matching Results” database 32 is provided to store the current obtained list of “candidate” devices d and corresponding membership card ID m bindings. Then, the compatibility checking process is repeated for the procurement data constructed for a next customer membership card m detected as having conducted procurement transactions at a set of stores by returning to step 110 to obtain a new customer transaction list Pₘ, and the compatibility checking process steps 110-120 are repeated.

Otherwise, at step 120, if it is determined that the device d is not compatible with the transaction i conducted at that store (no spatio-temporal matching of either at the store), then the process may continue to step 130 to obtain the procurement data constructed for a next customer membership card m detected as having conducted procurement transactions at a set of stores and returning to step 110 to repeat running the process steps 110-120 for compatibility checking. It is understood that the method steps 105 of FIG. 8A are repeated for all membership card numbers that have conducted the transactions at stores S within the given time frame.

FIG. 8B shows an example compatibility checking methodology performed at 105, FIG. 7, for determining whether the detected customer mobile device is compatible with a store membership card ID or other membership ID number, e.g., according to a second example scenario in which user payments are conducted centrally. These method steps 205 are invoked to determine whether the detected customer device 32 belongs to or matches a customer membership (e.g., membership ID, banking or credit card number, etc.) or not. In this example scenario, the method steps are the same as the method steps 105 depicted in FIG. 8A except that at the cash desk, there might be multiple stores' product transactions being paid. Thus, using the same annotation as described herein with respect to the method 105 of FIG. 8A, the method at 207 of FIG. 8B first divides the payment into multiple payment records and the payment account location information is enhanced. For example, in one centralized payment transaction, a customer may pay the bill for a first (“Gucci”) product and a second “Apple” product; thus this transaction will be broken into two records, one for the Gucci store, another for the Apple store.

In FIG. 8A, at 210, generated at the device matching engine from the stored data 58 is a payment transaction list Pₘ for payments/transactions associated with a customer having a membership card m in the given time interval, e.g., one day, according to

Pₘ=List{Pₘᵢ=(tₘᵢ,sₘᵢ,aₘᵢ):i=1,2, . . . pₘ,sₘᵢεS}

where, as before, tₘᵢ are the individual transaction(s) payment timestamp(s) of a membership card m belonging to a customer of a corresponding procurement i (i.e., transaction at a store) at the account desk; sₘᵢ is the respective store in which the transactions had been conducted (transaction or procurement i) by a customer associated with membership card m; and aₘᵢ is additional information indicating the payment account desk location, e.g., an identifier of the centralized payment entity or account location, for the member m paying for products conducted for transaction (or procurement) i. The method further includes at 215, generating at the device matching engine, from the stored data 52, the “Visiting” device list V_{d} comprising a list of those devices d detected a store j in the same time interval, e.g., one day, as given as:

V_{d}=List{V_{dj}=(t_{dj}^{S}t_{dj}^{E},s_{dj}):j=1,2, . . . v_{d},s_{dj}εS}

Then, at 220, FIG. 8B, the device matching engine performs compatibility checking by determining whether the transaction list Pₘ and the visiting list V_{d} are “compatible” with each other according to the second payment scheme. A transaction list Pₘ and a visiting list V_{d} are “compatible” with each other if: the device d location is near aₘᵢ at tₘᵢ; and

∀i=1,2, . . . ,pₘ,∃jε[1,v_{d}],whence tₘᵢ<t_{dj}^{E} and sₘᵢ=s_{dj}

In this centralized payment embodiment, for compatibility checking at 220, for each procurement i, a determination is made as to whether any procurement transaction centralized payment verification timestamp tₘᵢ for a customer membership card m conducted at a store sₘᵢ occurs before an end time interval for that device, i.e., time t_{dj}^{E} as recorded for the tracked device d detected at that store j, such that tₘᵢ<t_{dj}^{E}, and further that the stores are the same, i.e., sₘᵢ=s_{dj}. This could be performed in real-time, as the data becomes available, or in batch, or off-line mode. However, in this embodiment, a further check is made as to whether the device d is detected at a centralized payment desk location a at transaction i's recorded payment timepoint tₘᵢ. For any compatibility match detected, this potentially indicates that the customer associated with the matched device d may be the same customer who had conducted the transaction tₘᵢ with a membership card m, i.e., the customer's payment time to a SKU (belonging to the store) is within that customer's stay duration in that store. Thus, in the centralized payment scenario, to reduce the feasible matching number, a check is made to insure the mobile device ID should show up around account desk around tₘᵢ (when that customer pays money at account desk).

Thus, at 220, if it is determined that the device d is compatible with the transaction i at a store sₘᵢ=s_{dj}, and if the device d was located near aₘᵢ at tₘᵢ (payment conducted at that centralized desk store at tₘᵢ) based on the spatio-temporal matching of both, then this compatibility checking result information is stored at 225 in the “Matching Results” candidate list database 32. Then, the compatibility checking process is repeated for the procurement data constructed for a next customer membership card m detected as having conducted procurement transactions at a set of stores by returning to step 210 to obtain a new customer transaction list Pₘ and the process steps 210-220 are repeated for compatibility checking.

Otherwise, at step 220, if it is determined that the device d is not compatible with the transaction i conducted at that centralized payment desk (no spatio-temporal matching of either at the store), then the process may continue to step 230 to obtain the procurement data constructed for a next customer membership card m detected as having conducted a payment transactions for prior purchases at one or more stores and returning to step 210 to repeat running the process steps 210-220 for compatibility checking. It is understood that the method steps 205 of FIG. 8B are repeated for all membership card numbers that have conducted the transactions at centralized payment location within the given time frame.

Returning to FIG. 7, after the compatibility checking is performed at step 105 for the current membership card ID m (whether via method 105 of FIG. 8A or method 205 of FIG. 8B), the method proceeds to step 150, where a determination is made as to whether a binding of this membership card m to the detected device d has already been verified, i.e., a transaction using membership card m card was already matched to a device d using the methods described herein. If the current membership card m has been determined to be already bound to a device, e.g., the spatio-temporal processing of FIGS. 8A, 8B has already established that the current processed membership card ID m is bound to a current tracked user device d, then the process proceeds to step 152 for determining whether the verified binding includes a checked compatible combination, e.g., in the current candidate list of candidate bindings. If, at 152, it is determined that the verified binding is in the current list of candidate bindings, the process terminates at 154. Otherwise, at 155, if it is determined that the verified binding is not in the current list of candidate bindings, the system generates and displays a warning message and the process proceeds to step 160.

Otherwise, returning to step 150, if it is determined that there is no binding of this membership card m to a detected device d, the process proceeds to step 160.

At, 160, FIG. 7, a determination is then made as to whether there is a single candidate device d that could possibly bind to the current membership card m. If there is a single candidate device that could possibly bind to the current membership card m, then the process proceeds to step 163 where the potential binding is indicated as a primary binding. Otherwise, at 160, if it is determined that there is more than one single candidate device that could possibly bind to the current membership card m, then the process proceeds to step 165 where a determination is made as to whether the current detection was implemented as part of a centralized payment scheme. If, the current detection was implemented as part of a centralized payment scheme, then at 168, the method at the device matching engine performs a binding possibility calculation of centralized payment. Otherwise, at 165, if the current detection was not implemented as part of a centralized payment scheme, then the process proceeds to 170 where the device matching engine performs a binding possibility calculation of a store payment.

In one embodiment, the method for calculating the binding possibility calculation in centralized payment scheme at 168 of FIG. 7 and the method for calculating the binding possibility calculation in a store payment scheme at step 170 of FIG. 7 both determine and make use of a queue length to estimate a “waiting” time, i.e., a time it takes for customer to pay the transaction at the centralized payment desk or point of purchase terminal in the store. FIG. 9 conceptually depicts a queue “waiting time” and a “leave” time that is computed for obtaining candidate bindings, e.g., and more accurate determine the time interval in which a customer of the device d has paid for the transaction whether at the centralized desk or at a store. As shown in FIG. 9, the waiting time includes the wait time on a queue within the detection zone (referred to as a detection “fence”) before the payment transaction is conducted at the cash desk 30. As shown in FIG. 9, the customer device d, e.g., tracked device 31A, has entered a payment queue 37B at a location that is covered by the tracking system's detection fence, which in the non-limiting embodiment depicted, may define the neighborhood 35 of multiple customer mobile devices 32 detected for potential binding, and waits in a queue, e.g., queue 37B, for payment. The waiting time will also include the average “leave” time corresponding to the time it takes for the customer of device d, e.g., tracked device 31B, to leave the tracking system's device detection fence area after finishing the payment transaction at centralized cash desk 30 (or in store). It is understood that the waiting time and average leave time would not be computed if the customer did not show up at any centralized desk to pay for the one or more store transactions.

Thus, from the data maintained by the system, in one embodiment, the device matching engine methods of FIG. 8A, 8B are enhanced with further method steps to calculate a possibility of a binding, for the device d, including obtaining the entry and exit time that the user entered the detection fence at the centralized payment location, i.e., its entry time and left time [t_{d}^{S}, t_{d}^{E}], e.g., as determined by the journey builder from tracking at or around the payment (point of sale) terminal or centralized cash desk. A transaction count pₘ is given as a tuple [tₘᵢ, aₘᵢ] about a transaction event, including the time and location. In one embodiment, assuming an average leave time after payment is given as t̅^{L}, and a variance is given as δ, the binding possibility function for that device d and identified membership card m for a transaction i is computed according to:

$$f ( d , m , i ) = \frac{1}{1 - b} \cdot \frac{1}{\sqrt{2 π} δ} {e}^{( \frac{{( {t}_{d}^{L} - {t}_{mi} - {\overline{t}}^{L} )}^{2}}{2 {δ}^{2}} )}$$

wherein

$$b = {\int }_{- ∞}^{0} \frac{1}{\sqrt{2 π} δ} {e}^{( \frac{{( x - {\overline{t}}^{L} )}^{2}}{2 {δ}^{2}} )} d x$$

and ensures that the sum possibility ƒ(d,m) is normalized to a value between 0 and 1, and x is a temporary variable for use in the integration operation. and

$$f ( d , m ) = {\prod }_{i = 1}^{Pm} f ( d , m , i ) .$$

At last, ƒ(d,m) can be normalized over all the compatible devices to make a sum possibility as 1.

Further, given a car membership id m having multiple transactions, the possibility computation ƒ(d,m) is the product of the possibility ƒ(d,m, i) of each individual transaction i conducted.

Thus, as a non-limiting example, using the probability function ƒ(d,m) for determining a device d's compatibility for the membership ID m's i^{th} transaction, if the tracked “leave time” for the identified device d (when paying centrally or in the store) is close to the average leave time, then the computed ƒ(d,m) binding possibility will be much greater than the corresponding binding possibility value computed for when the tracked “leave” time value for the identified device d (when paying centrally or in the store) is much greater than or much smaller than the average leave time value.

As depicted in FIG. 7, the calculation of the ƒ(d,m) binding possibility function may be performed at step 168, 170 after performing the compatibility checking in either payment scenario, i.e., whether at a centralized payment cash desk 30, or whether at an individual store when payment for the transaction is conducted at the store. In the example payment at each store scenario, the calculating of the ƒ(d,m) binding possibility function at step 170, FIG. 7 is similar as to the centralized payment formula. However, for a customer of device d that has performed multiple transactions within a single store visit, the data for the last transaction is kept for performing the possibility calculation associated with that customer card m.

Thus, for device-membership matching, the membership matching engine 75 analyzes the spatio-temporal occurrence and sequence of transactions to build up the feasible link and their matching (binding) possibility. In addition, the system can also use historical data to update the linkage and possibility adaptively. With this system, a physical store can automatically build the linkage without bothering device users or high cost/effort. Thus, in a non-limiting application, historical data that may be stored as a database record in a server of a department store, and including the location, payment, and matching information in their server, can be used in the later-batch mapping calculation.

Returning back to FIG. 6, the final step performed by the device matching engine 75 is a binding update management step 96 for managing the list(s) of candidate and verified bindings.

That is, at step 96, FIG. 6, the device matching engine 75 adaptively updates the matching information based on recent more inbound data. In one embodiment, the device matching engine 75 records and stores binding status information between a device d and a membership card ID m. One status indicator includes, for a membership card ID, whether there is a confirmed_device_ID, i.e., a device d in which there is confirmed with 100% certainty (e.g., confirmed by the customer) that the device ID is bound to the membership card ID. A further binding status indicator includes a suspected_device_ID, i.e., a device d, in which it may be confirmed, however with less than 100% certainty, that the device ID is bound to the membership card ID. A further binding status indicate for the device ID indicates that one or more device IDs have been computed as potentially binding to a membership card ID. Thus, in a non-limiting embodiment, a binding data schema is maintained by the binding update management component for the device matching engine 75 to manage the list(s) of candidate and verified bindings. Such a maintained data schema may include a list of detected membership card IDs, and for each detected membership card ID on the list, an associated indication of a confirmed_device ID that is bound to that member, or a single suspected device ID of a mobile device determined as potentially binding. As there can be many suspected device ID's of a mobile device determined as potentially binding, each of the suspected device IDs may be listed with their associated computed binding probability measure for that membership card ID on the list. Thus, in one embodiment, the device matching engine may generate and store a binding data schema as a data structure according to:

List{ membership_ID, confirmed_device_ID, suspected_device_ID,

List{ (device_ID, possiblity)}

}

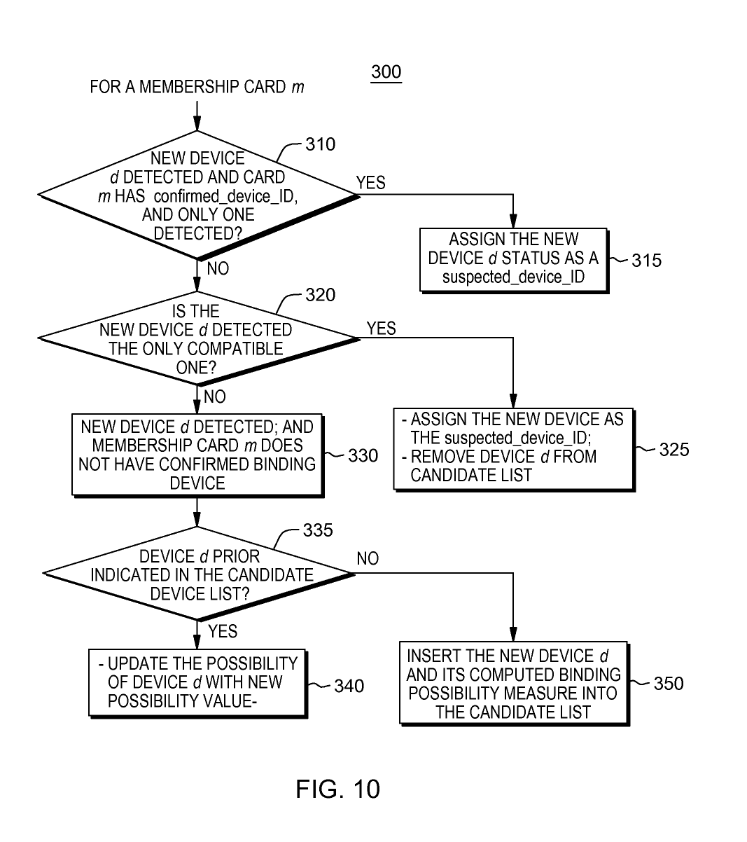

FIG. 10 shows a method 300 for managing binding updates according to one embodiment. For a detected membership card m having a confirmed_device_ID, a first step 310 determines if any new device d is detected within a store and if it is the only one detected. If the current tracked mobile device d is a new device and the only one detected, then at 315, the method assigns a suspected_device_ID binding state to the new device d. However, at 310, if it is determined that the new device d detected within a store is not the only one detected, then the process proceeds to 320 where a determination is made as to whether the new detected device d is the only compatible one. If at 320 it is determined that the new detected device d is the only compatible one, then at 325 the method assigns device d with a status update as the suspected_device_ID for membership card m, and, if necessary, removes device d indication from the candidate list, e.g., maintained by the system in database 32, for example.

Returning to step 320, FIG. 10, if it is determined that the new device d detected is not the only compatible one, then the process proceeds to step 330 where it is assumed that for the membership card m, there is no confirmed binding device ID. Then, at 335 a determination is made as to whether the device_ID has been prior placed on the candidate device list. If at 335, it is determined that the device_ID has been prior placed on the candidate device list, then in one embodiment, the device matching engine binding update management performs updating the possibility p^{old} of device d with a new binding possibility value p^{new} according to:

p^{new}=max{p^{old},f(d,m)}

where p^{old} is the prior computed binding possibility measure (value) for the device d and f(d, m) is the new computed binding probability value for that new device d and membership card ID m. Otherwise, if at 335 it is determined that the device_ID has not been prior placed on the candidate device list, then at 350, for the new device d detected and with the membership card m determined as not having a confirmed binding device, the method inserts the new device and its computed binding possibility measure into the candidate list.

FIG. 11 illustrates one embodiment of an exemplary hardware configuration of a computing system 400 programmed to perform the method steps for building a mobile device's he POI visiting journey, constructing procurement lists, and implementing the device and membership identity matching functionality as described herein with respect to FIGS. 7, 8A-8B and 10. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automatic binding of a membership card identifier (ID) with a mobile device identifier (ID) comprising:
tracking, using a wireless electronic device tracking system, physical locations of one or more stores visited by a customer's mobile electronic device, said tracking including identifying the customer's mobile device identifier (ID);
building, at a processor device, a first data structure representing a trajectory corresponding to the movement of the customer's tracked mobile electronic device at one or more store locations, and a time interval thereof corresponding to an amount of time visited at each location;
building, at the processor device, a second data structure representing one or more purchase transactions conducted by customers at various store locations, each customer purchase transaction indicating a membership card ID associated with the customer, and a corresponding purchase payment time point; and
identifying, at said processor device, from said first and second data structures, a compatible match indicating a potential binding of a customer's mobile device ID to a membership card ID, said identifying a compatible match including detecting when a purchase payment time point associated with a customer membership card ID and for a purchase conducted at a particular store location matches a time interval window recorded for a tracked customer mobile device detected at that store location,
wherein said compatibility match identifying occurs seamless to said customer.

2. The method for automatic binding of claim 1, wherein said tracking comprises:
recording in real-time a customer's mobile electronic device location when visiting a store location and storing said recorded data representing said visiting, wherein said building said first data structure comprises:
obtaining, from a memory storage device, any identified points of interest visited by said customer in a relevant time interval, each point of interest corresponding to one of: a store location or a transaction payment terminal, said store location or transaction payment terminal having a corresponding identifier (POI_ID); and
generating a list including one or more device_IDs, and, for each device_ID, generating a corresponding list of one or more physical locations that each device_ID had visited in a corresponding time interval, said corresponding time interval including a time of entry and a corresponding exit time at that point of interest, and the POI_ID of the point of interest visited at the corresponding time interval.

3. The method for automatic binding of claim 2, further comprising:
recording, in a memory storage device, one or more recent purchasing transactions conducted at transaction payment terminal by a user using a membership card ID when visiting one or more points of interest, said recorded data representing said purchase transaction and an associated product identifier of a purchased product, wherein said building said second data structure comprises:
obtaining, from the memory storage device, data representing one or more recent purchase transactions conducted by a user with said membership card ID at a point of interest; and
generating a list including one or more user membership card IDs of said recent purchasing transactions, and, for each membership card ID, generating a corresponding list of identifiers of one or more store locations which the user had conducted the corresponding recent purchase transaction, and a corresponding payment time point for the purchase transaction.

4. The method for automatic binding of claim 3, wherein said transaction payment terminal is one of: located within a visited store location in which a customer purchase is made, or located at a different location according to a centralized transaction payment scheme wherein purchase transactions are paid at a subsequent time point at said different location, wherein said generated list of identifiers of one or more store locations which the user had conducted the corresponding recent purchase transaction includes an identifier of an authorized terminal of an entity accepting payment for the user purchases at the one or more store locations.

5. The method for automatic binding of claim 4, wherein said identifying, at said processor device, from said first and second data structures, a compatible match indicating a potential binding of a detected customer's mobile device ID to a membership card ID, further comprises:
detecting when a purchase payment time point tₘᵢ conducted according to said centralized transaction payment scheme and associated with a customer membership card ID m and a prior product purchase transaction i conducted at a particular store location occurs prior to a time point recorded for that customer membership card ID m exiting that store location after obtaining the purchased product according to said centralized transaction payment scheme; and
the customer's mobile electronic device d has been physically detected at or near a purchase payment terminal location aₘᵢ at the recorded payment time point tₘᵢ.

6. The method for automatic binding of claim 1, further comprising:
calculating, by said processor device, a probability measure of a potential binding of a membership card identifier ID m with a mobile device identifier ID.

7. The method for automatic binding of claim 6, wherein said probability measure calculating comprises:
determining a wait time indicating a time a detected device d of membership card identifier ID m waits on a queue prior to said payment time point at a purchase payment terminal location; and
determining a leave time indicating a time after said payment time point it takes for said detected device d of membership card identifier ID m to leave a pre-defined area proximate the purchase payment terminal location, said wait time and leave time defining a time interval window recorded for a membership card ID m payment at an associated payment terminal location; and
computing said probability measure of a potential binding of a membership card identifier ID m with a mobile device identifier ID using a binding probability function and at least said determined leave time.

8. The method for automatic binding of claim 7, wherein said binding probability function ƒ(d,m,i) for a device d and identified membership card m for a transaction i used to compute said binding probability measure is according to:
$$f ( d , m , i ) = \frac{1}{1 - b} \cdot \frac{1}{\sqrt{2 π} δ} {e}^{( \frac{{( {t}_{d}^{L} - {t}_{mi} - {\overline{t}}^{L} )}^{2}}{2 {δ}^{2}} )}$$
wherein
$$b = {\int }_{- ∞}^{0} \frac{1}{\sqrt{2 π} δ} {e}^{( \frac{{( x - {\overline{t}}^{L} )}^{2}}{2 {δ}^{2}} )} d x$$
such that a sum possibility ƒ(d,m) is normalized to a value between 0 and 1, t̅^{L} is an average leave time after payment, and δ is a variance.

9. The method for automatic binding of claim 8, wherein for an identified membership card m recorded as having conducted multiple transactions i, said binding probability function is computed according to:
$$f ( d , m ) = {\prod }_{i = 1}^{Pm} f ( d , m , i ) ,$$
wherein Pm represents a total number of transactions conducted.

10. The method for automatic binding of claim 1, further comprising:
automatically adaptively updating a compatibility matching status between a device ID and a membership card ID based on more recently obtained data.

11. A system for automatic binding of a membership card identifier (ID) with a mobile device identifier (ID) comprising:
a wireless electronic device tracking system for tracking physical locations of one or more stores visited by a customer's mobile electronic device, said tracking including identifying the customer's mobile device identifier (ID);
a memory storage device, and
a hardware processor device coupled to the memory storage device, said hardware processor configured to perform a method to:
build a first data structure representing a trajectory corresponding to the movement of the customer's tracked mobile electronic device at one or more store locations, and a time interval thereof corresponding to an amount of time visited at each location;
build a second data structure representing one or more purchase transactions conducted by customers at various store locations, each customer purchase transaction indicating a membership card ID associated with the customer, and a corresponding purchase payment time point; and
identify from said first and second data structures, a compatible match indicating a potential binding of a customer's mobile device ID to a membership card ID, said identifying a compatible match including detecting when a purchase payment time point associated with a customer membership card ID and for a purchase conducted at a particular store location matches a time interval window recorded for a tracked customer mobile device detected at that store location,
wherein said compatibility match identifying occurs seamless to said customer.

12. The system for automatic binding of claim 11, wherein to track physical locations of one or more stores visited, said hardware processor is further configured to:
record in real-time a customer's mobile electronic device location when visiting a store location and storing said recorded data representing said visiting, wherein to build said first data structure, said hardware processor is further configured to:
obtain, from a memory storage device, any identified points of interest visited by said customer in a relevant time interval, each point of interest corresponding to one of: a store location or a transaction payment terminal, said store location or transaction payment terminal having a corresponding identifier (POI_ID); and
generate a list including one or more device_IDs, and, for each device_ID, generate a corresponding list of one or more physical locations that each device_ID had visited in a corresponding time interval, said corresponding time interval including a time of entry and a corresponding exit time at that point of interest, and the POI_ID of the point of interest visited at the corresponding time interval.

13. The system for automatic binding of claim 12, wherein said hardware processor is further configured to:
record, in a memory storage device, one or more recent purchasing transactions conducted at transaction payment terminal by a user using a membership card ID when visiting one or more points of interest, said recorded data representing said purchase transaction and an associated product identifier of a purchased product, wherein to build said second data structure, said hardware processor is further configured to:
obtain, from the memory storage device, data representing one or more recent purchase transactions conducted by a user with said membership card ID at a point of interest; and
generate a list including one or more user membership card IDs of said recent purchasing transactions, and, for each membership card ID, generate a corresponding list of identifiers of one or more store locations which the user had conducted the corresponding recent purchase transaction, and a corresponding payment time point for the purchase transaction.

14. The system for automatic binding of claim 13, wherein said transaction payment terminal is one of: located within a visited store location in which a customer purchase is made, or located at a different location according to a centralized transaction payment scheme wherein purchase transactions are paid at a subsequent time point at said different location, wherein said generated list of identifiers of one or more store locations which the user had conducted the corresponding recent purchase transaction includes an identifier of an authorized terminal of an entity accepting payment for the user purchases at the one or more store locations.

15. The system for automatic binding of claim 14, wherein to identify, at the hardware processor, from said first and second data structures, a compatible match indicating a potential binding of a detected customer's mobile device ID to a membership card ID, said hardware processor is further configured to:
detect when a purchase payment time point tₘᵢ conducted according to said centralized transaction payment scheme and associated with a customer membership card ID m and a prior product purchase transaction i conducted at a particular store location occurs prior to a time point recorded for that customer membership card ID m exiting that store location after obtaining the purchased product according to said centralized transaction payment scheme; and
the customer's mobile electronic device d has been physically detected at or near a purchase payment terminal location aₘᵢ at the recorded payment time point tₘᵢ.

16. The system for automatic binding of claim 11, wherein said hardware processor is further configured to:
calculate a probability measure of a potential binding of a membership card identifier ID m with a mobile device identifier ID;
determine a wait time indicating a time a detected device d of membership card identifier ID m waits on a queue prior to said payment time point at a purchase payment terminal location; and
determine a leave time indicating a time after said payment time point it takes for said detected device d of membership card identifier ID m to leave a pre-defined area proximate the purchase payment terminal location, said wait time and leave time defining a time interval window recorded for a membership card ID m payment at an associated payment terminal location; and
compute said probability measure of a potential binding of a membership card identifier ID m with a mobile device identifier ID using a binding probability function and at least said determined leave time.

17. The system for automatic binding of claim 16, wherein said binding probability function ƒ(d,m,i) for a device d and identified membership card m for a transaction i used to compute said binding probability measure is according to:
$$f ( d , m , i ) = \frac{1}{1 - b} \cdot \frac{1}{\sqrt{2 π} δ} {e}^{( \frac{{( {t}_{d}^{L} - {t}_{mi} - {\overline{t}}^{L} )}^{2}}{2 {δ}^{2}} )}$$
wherein
$$b = {\int }_{- ∞}^{0} \frac{1}{\sqrt{2 π} δ} {e}^{( \frac{{( x - {\overline{t}}^{L} )}^{2}}{2 {δ}^{2}} )} d x$$
such that a sum possibility ƒ(d,m) is normalized to a value between 0 and 1, t̅^{L} is an average leave time after payment, and δ is a variance; and wherein for an identified membership card m recorded as having conducted multiple transactions i, said binding probability function is computed according to
$$f ( d , m ) = {\prod }_{i = 1}^{Pm} f ( d , m , i ) ,$$
wherein Pm represents a total number of transactions conducted.

18. The system for automatic binding of claim 11, wherein said hardware processor is further configured to: automatically adaptively update a compatibility matching status between a device ID and a membership card ID based on more recently obtained data.

19. A computer program product for automatic binding of a membership card identifier (ID) with a mobile device identifier (ID), the computer program product comprising a computer readable storage medium readable by a machine and storing instructions run by the machine to perform a method, said method comprising:
tracking, using a wireless electronic device tracking system, physical locations of one or more stores visited by a customer's mobile electronic device, said tracking including identifying the customer's mobile device identifier (ID);
building, at a processor device, a first data structure representing a trajectory corresponding to the movement of the customer's tracked mobile electronic device at one or more store locations, and a time interval thereof corresponding to an amount of time visited at each location;
building, at the processor device, a second data structure representing one or more purchase transactions conducted by customers at various store locations, each customer purchase transaction indicating a membership card ID associated with the customer, and a corresponding purchase payment time point; and
identifying, at said processor device, from said first and second data structures, a compatible match indicating a potential binding of a customer's mobile device ID to a membership card ID, said identifying a compatible match including detecting when a purchase payment time point associated with a customer membership card ID and for a purchase conducted at a particular store location matches a time interval window recorded for a tracked customer mobile device detected at that store location, wherein said compatibility match identifying occurs seamless to said customer.

20. The computer program product according to claim 19, wherein the tracking comprises:
recording in real-time a customer's mobile electronic device location when visiting a store location and storing said recorded data representing said visiting, wherein said building said first data structure comprises:
obtaining, from a memory storage device, any identified points of interest visited by said customer in a relevant time interval, each point of interest corresponding to one of: a store location or a transaction payment terminal, said store location or transaction payment terminal having a corresponding identifier (POI_ID); and
generating a list including one or more device_IDs, and, for each device_ID, generating a corresponding list of one or more physical locations that each device_ID had visited in a corresponding time interval, said corresponding time interval including a time of entry and a corresponding exit time at that point of interest, and the POI_ID of the point of interest visited at the corresponding time interval.

21. The computer program product according to claim 20, further comprising:
recording, in a memory storage device, one or more recent purchasing transactions conducted at transaction payment terminal by a user using a membership card ID when visiting one or more points of interest, said recorded data representing said purchase transaction and an associated product identifier of a purchased product, wherein said building said second data structure comprises:
obtaining, from the memory storage device, data representing one or more recent purchase transactions conducted by a user with said membership card ID at a point of interest; and
generating a list including one or more user membership card IDs of said recent purchasing transactions, and, for each membership card ID, generating a corresponding list of identifiers of one or more store locations which the user had conducted the corresponding recent purchase transaction, and a corresponding payment time point for the purchase transaction.
